(19) United States
(12) Patent Application Publication
(10) Pub. No.: US 2019/0135041 A1
(43) Pub. Date: May 9, 2019

(54) PNEUMATIC TIRE

(71) Applicant: TOYO TIRE & RUBBER CO., LTD., Itami-shi (JP)

(72) Inventor: Toshikazu Yasunaga, Itami-shi (JP)

(73) Assignee: TOYO TIRE & RUBBER CO., LTD., Itami-shi (JP)

(21) Appl. No.: 16/167,779

(22) Filed: Oct. 23, 2018

(30) Foreign Application Priority Data
Nov. 8, 2017 (JP) 2017-215879

(51) Int. Cl. B60C 11/01; B60C 11/03; B60C 11/11; B60C 11/12; B60C 11/16

(52) U.S. Cl. CPC B60C 11/01; B60C 11/0309; B60C 11/11; B60C 2011/1213; B60C 11/1236; B60C 11/1625; B60C 2011/0358; B60C 11/1204

(57) ABSTRACT

A pneumatic tire includes a shoulder block on an outer side in the tire width direction. The pneumatic tire includes an edge portion protruding from an end portion of the shoulder block located on the outer side in the tire width direction toward a tire step-in side so as to be inclined toward the center side in the tire width direction.

### CROSS-REFERENCE TO RELATED APPLICATIONS

This application claims priority based on Japanese Patent Application No. 2017-215879 filed on Nov. 8, 2017, the contents of which are incorporated herein by this reference.

### BACKGROUND OF THE INVENTION

### Technical Field

The present invention relates to a pneumatic tire.

### Related Art

Conventionally, a pneumatic tire having a protruding portion formed on a side surface constituting a buttless portion of a land portion has been known (for example, see Japanese Patent No. 5753014).

However, the above conventional pneumatic tire is provided with a protruding portion only for the purpose of cooling a tread portion, so that the conventional pneumatic tire has no function for improving the snow traction performance and the rut travel performance. Besides, there is no mention regarding this point.

### SUMMARY

An object of the present invention is to provide a pneumatic tire capable of improving the snow traction performance and the rut travel performance.

The present invention provides, as a means for solving the above problem, a pneumatic tire including a shoulder block on an outer side in a tire width direction; and an edge portion protruding from an end portion of the shoulder block located on the outer side in the tire width direction toward a tire rotational direction so as to be inclined toward a center side in the tire width direction.

With this configuration, the edge portion bites into snow when running on a snow surface. That is, since the edge portion protrudes with being inclined, a protruding portion of a distal end bites in first and gradually increases its bite amount as the tire rotates. This makes it possible to improve the snow traction performance and the rut travel performance.

It is preferable that the pneumatic tire includes a plurality of edge portions.

This configuration makes it possible to further improve the snow traction performance and the rut travel performance.

It is preferable that the shoulder block has a plurality of sipes extending in the tire width direction and partitioning an outer surface side in a tire circumferential direction, and each of the edge portions is formed in correspondence with each region partitioned by the sipes.

With this configuration, it is possible to effectively exhibit the snow biting effect of the sipes and the edge portions, and to further improve the snow traction performance and the rut travel performance.

According to the present invention, it is possible to improve the snow traction performance and the rut travel performance by forming an edge portion at an end portion of a shoulder block.

### BRIEF DESCRIPTION OF THE DRAWINGS

The foregoing and the other feature of the present invention will become apparent from the following description and drawings of an illustrative embodiment of the invention in which:

FIG. 1 is a partial development view of a pneumatic tire according to the present embodiment; and

FIG. 2 is a partially enlarged perspective view including an edge portion in FIG. 1.

### DETAILED DESCRIPTION OF EMBODIMENTS

An embodiment of the present invention will be described below with reference to the accompanying drawings. It should be noted that the following description is merely exemplary in nature and is not intended to limit the invention, its applicable objects, and its applications.

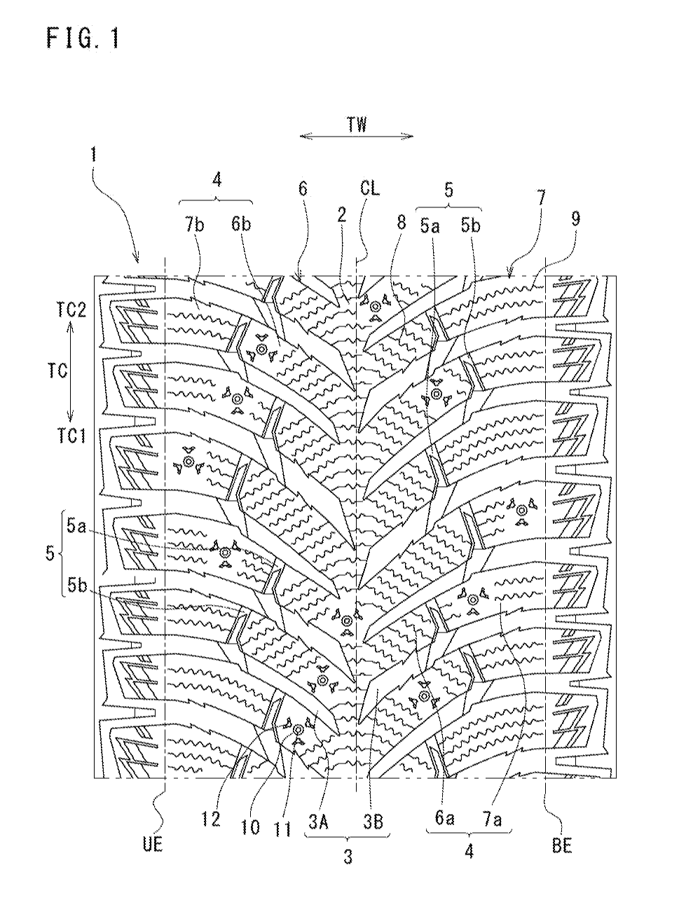

FIG. 1 is a partial development view of a tread portion 1 of a pneumatic tire according to the present embodiment. Referring to FIG. 1, reference symbol TC denotes a tire circumferential direction; and TW, a tire width direction. In addition, reference symbol CL denotes the center line (equator line) of the tread portion 1 in the tire width direction. Further, reference symbols UE and BE respectively denote the ground contact ends of both ends of the tread portion 1 in the tire width direction.

A center rib 2 annularly continuous in the tire circumferential direction on the center line CL is formed on the tread portion 1. On both sides of the center rib 2 in the tire width direction TW, inclined blocks 4 defined by inclined grooves 3 as an example of lateral grooves extend. As a result, the inclined blocks 4 are arranged at predetermined intervals in the tire circumferential direction TC.

The inclined grooves 3 are inclined in one direction of the tire circumferential direction TC, that is, in an opposite direction TC2 of a tire rotational direction TC1 toward the tire width direction TW. The inclined groove 3 includes a wide first inclined groove A and a narrow second inclined groove B. The first inclined grooves A and the second inclined grooves B are alternately arranged in the tire circumferential direction. Portions of both side edges of the first inclined groove A are formed in a zigzag shape. The inclined grooves 3 formed on both sides of the center line CL are located with being displaced in the tire circumferential direction TC. The distal end portion of the first inclined groove A is substantially located on the center line CL.

A longitudinal groove 5 is formed midway in the inclined block 4. The longitudinal groove 5 is inclined in the tire rotational direction TC1 toward the tire width direction TW and is in substantially orthogonal communication with the first inclined groove A and the second inclined groove B on both sides. As a result, the inclined block 4 is separated into a center block 6 and a shoulder block 7. In addition, the longitudinal grooves 5 are alternately displaced between the inclined blocks 4 arranged in the tire circumferential direction on the center side and the lateral sides in the tire width direction. Owing to a first longitudinal groove 5a on the center side, the inclined block 4 is divided into a short first center block 6a and a long first shoulder block 7a. Owing to a second longitudinal groove 5b on the lateral side, the inclined block 4 is divided into a long second center block 6b and a short second shoulder block 7b.

In the center rib 2 and the center block 6 following the center rib 2, first sipes 8 are formed radially around the center rib 2 side. Two or three second sipes 9 are formed in the shoulder block 7 along the longitudinal direction of the shoulder block. The sipes 8 and 9 each have a waveform. One end of the first sipe 8 communicates with the inclined groove 3, and the other end of the first sipe 8 terminates in the center rib 2 or the center block 6. One end of the second sipe 9 communicates with the longitudinal groove 5, and the other end of the second sipe 9 terminates in the shoulder block 7.

A pin region 10 is formed in each of the blocks 6 and 7. The sipes 8 and 9 are not formed in the pin region 10. A pin hole (not shown) is formed in the center portion of each pin region 10, and a stud pin 11 is mounted in the pin hole. Three recesses 12 are formed at equal angular intervals in the periphery of each pin hole.

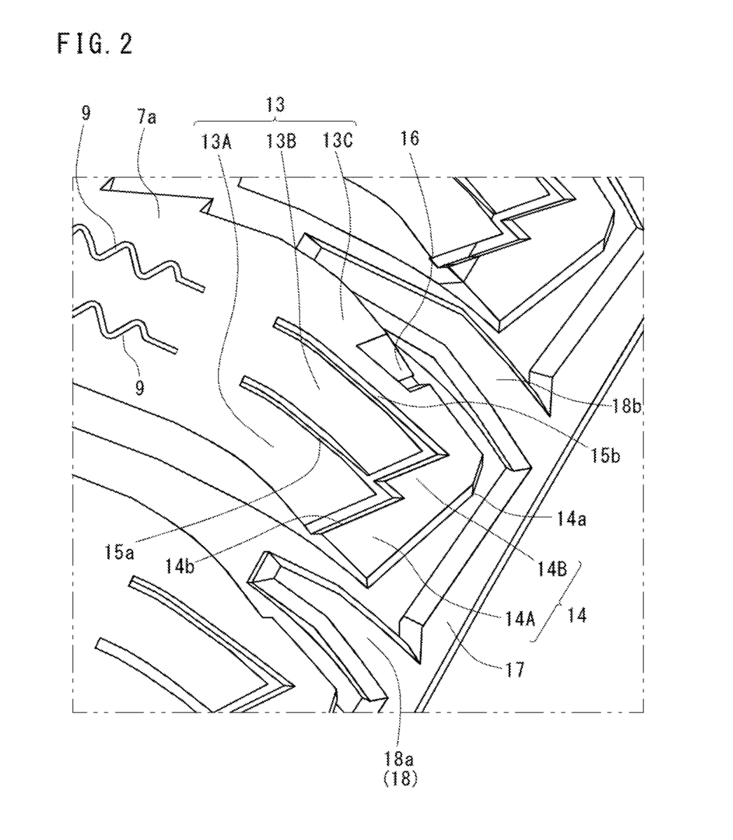

As shown in FIG. 2, the shoulder block 7 is curved gradually from the contact surface side to the inside in the tire radial direction. On the outer side in the tire width direction midway along the curved portion, an inclined portion 13 is formed which gradually decrease in the size of protrusion from the groove bottom of the inclined groove 3 toward the outer side in the tire width direction. An edge portion 14 is formed on an end portion located on the outer side in the tire width direction relative to the inclined portion 13.

The inclined portion 13 is divided into three parts by two rows of narrow grooves 15a and 15b extending in the tire width direction, and includes a first inclined portion 13A, a second inclined portion 13B, and a third inclined portion 13C in the order from the tire rotational direction side. In the shoulder block 7 provided with two second sipes 9, each of the narrow grooves 15 is located on an extension line of the second sipe 9, and the narrow grooves 15a and 15b and the second sipe 9 divide the shoulder block 7 into three parts in the tire circumferential direction. In the shoulder block 7 provided with three second sipes 9, one of the narrow grooves 15 is located on an extension line of the second sipe 9, and the other sipe is located in the middle of the remaining two second sipes 9 and divides the shoulder block 7 into three parts in the tire circumferential direction.

The distal end portions of the first inclined portion 13A and the second inclined portion 13B are inclined toward the center side in the tire width direction toward the tire rotational direction TC1. The third inclined portion 13C is continuous with the edge portion 14 to be described later. A half portion of the distal end portion of the third inclined portion 13C which is located on the second inclined portion 13B side is directly continuous with the edge portion 14, but a recess portion 16 is formed midway in the remaining half portion.

The edge portion 14 extends to the outer side in the tire width direction from the third inclined portion 13C, and then extends in the tire rotational direction TC1 along the outer edges of the second inclined portion 13B and the first inclined portion 13A. A portion along the first inclined portion 13A is a first edge portion 14A and a portion along the second inclined portion 13B is a second edge portion 14B.

An outer edge 14a of the edge portion 14 is chamfered and then inclined to the center in the tire width direction toward the tire rotational direction. An inner edge 14b of the edge portion 14 is formed in a sawtooth shape along the first inclined portion 13A and the second inclined portion 13B. That is, the distal end portions of the first edge portion 14A and the second edge portion 14B in the tire rotational direction TC1 have acute angles, making it easier for the first edge portion 14A and the second edge portion 14B to bite into the snow surface.

On the outer side of the shoulder block 7 in the tire width direction, a protrusion line 17 extending in the tire circumferential direction and being annularly continuous and a protrusion 18 extending from the protrusion line 17 into each inclined groove 3 are formed. The protrusion 18 extends into the inclined groove 3 and includes a first protrusion 18a having a long protruding length from the protrusion line 17 and a second protrusion 18b having a protruding length shorter than that of the first protrusion 18a. The first protrusion 18a and the second protrusion 18b are alternately arranged in the tire circumferential direction.

According to the pneumatic tire having the above configuration, when attention is paid to the action of the edge portion 14 at the time of traveling on the snow surface, the distal end portion of the first edge portion 14A first bites into the snow. The distal end portion of the first edge portion 14A protrudes and is sharp, making it easy for the distal end to bite into the snow surface. When the tire rotates, the distal end portion of the second edge portion 14B then bites into the snow surface. Since the second edge portion 14B also has the same shape as the first edge portion 14A, it is also possible to obtain a satisfactory biting state with respect to the snow surface. That is, the first edge portion 14A and the second edge portion 14B can bite into the snow surface in two stages.

In addition, the first edge portion 14A and the second edge portion 14B are provided in correspondence with the respective regions divided by the second sipes 9. The distal end of the second edge portion 14B and the narrow groove 15a are further aligned with the location of the second sipe 9. Further, the location of the narrow groove 15b is made to coincide with the location of the second sipe 9. As a result, it is possible to synergistically exert the edge effect of making each region bite into the snow surface.

According to the pneumatic tire having the edge portion 14 formed as described above, the edge portion 14 can bite into the snow surface at the time of traveling on the snow surface, and the snow traction performance can be improved. Also, even at the time of traveling on the rutted snow surface, the edge portion 14 acts on the inner surface portion constituting the rut to improve the running performance (rut travel performance) on the rutted road surface. At the same time, it is possible to make the second sipes 9 and the narrow grooves 15a and 15b exert the edge effect to further improve the snow traction performance and the rut travel performance.

Note that the present invention is not limited to the configuration described in the above embodiment, and various modifications can be made.

In the above embodiment, the number of the edge portions 14 is two, but may be one or three or more. In the case of providing the three edge portions 14 in the above embodiment, each edge portion may be formed at a position corresponding to the third inclined portion 13C. Further, the inclination angle of the edge can be freely set.

What is claimed is:

1. A pneumatic tire comprising:
a shoulder block on an outer side in a tire width direction; and
an edge portion protruding from an end portion of the shoulder block located on the outer side in the tire width direction toward a tire rotational direction so as to be inclined toward a center side in the tire width direction.

2. The pneumatic tire according to claim 1, which includes a plurality of edge portions.

3. The pneumatic tire according to claim 1, wherein
the shoulder block has a plurality of sipes extending in the tire width direction and partitioning an outer surface side in a tire circumferential direction, and
each of the edge portions is formed in correspondence with each region partitioned by the sipes.

4. The pneumatic tire according to claim 2, wherein
the shoulder block has a plurality of sipes extending in the tire width direction and partitioning an outer surface side in a tire circumferential direction, and
each of the edge portions is formed in correspondence with each region partitioned by the sipes.
